(19) United States
(12) Patent Application Publication
(10) Pub. No.: US 2025/0197728 A1
(43) Pub. Date: Jun. 19, 2025

(54) RECOVERY OF HEAT FROM DOWNSTREAM DISTILLATION

(71) Applicant: Eastman Chemical Company, Kingsport, TN (US)

(72) Inventors: Daryl Bitting, Longview, TX (US); Xianchun Wu, Longview, TX (US); Michael Gary Polasek, Longview, TX (US); David Eugene Slivensky, Tatum, TX (US); Avery L. Anderson, Longview, TX (US)

(73) Assignee: Eastman Chemical Company, Kingsport, TN (US)

(21) Appl. No.: 18/847,292

(22) PCT Filed: Mar. 15, 2023
(86) PCT No.: PCT/US2023/064379

§ 371 Date: Sep. 16, 2024

Related U.S. Application Data
(60) Provisional application No. 63/269,472, filed on Mar. 17, 2022.

(51) Int. Cl. C10G 1/02; B01D 3/00; B01D 3/14; C10B 53/07

(52) U.S. Cl. CPC C10G 1/02; B01D 3/007; B01D 3/14; C10B 53/07; C10G 2300/1003

(57) ABSTRACT

It has been discovered that heat energy may be captured from various process streams in a chemical recycling facility, such as the pyrolysis effluent streams, pyrolysis gas streams, and pyrolysis flue gas streams. More particularly, it has been discovered that residual heat energy from various process streams in a chemical recycling facility may be used to preheat waste plastic streams and provide heat for waste plastic pyrolysis. Consequently, the pyrolysis processes and systems described herein may obtain a lower carbon footprint.

### BACKGROUND

Waste plastic pyrolysis plays a part in a variety of chemical recycling technologies. The pyrolysis of waste plastic produces heavy components (e.g., waxes, tar, and char), as well as recycle content pyrolysis oil (r-pyoil) and recycle content pyrolysis gas (r-pygas). When the pyrolysis facility is located near another processing facility, such as a cracker facility, it is desirable to send as much of the r-pyoil and r-pygas as possible to the downstream processing facility to be used as a feedstock in forming other recycle content products (e.g., olefins, paraffins, etc.).

However, the combustion of fossil fuels is typically used to provide the heat to melt the waste plastics for the pyrolysis reaction and for the pyrolysis reaction itself. Consequently, this combustion of fossil fuels can increase CO₂ emissions. In other words, the present methods for melting the waste plastics and waste plastic pyrolysis generally requires the combustion of fossil fuels, which negatively affects the carbon footprint of the chemical recycling facility. Thus, a heat processing scheme for waste plastic pyrolysis that provides a lower carbon footprint is needed.

### SUMMARY

In one aspect, the present technology concerns a chemical recycling process. Generally, the process comprises: (a) liquefying at least a portion of a waste plastic in a liquification system to form a liquefied waste plastic; (b) pyrolyzing at least a portion of the liquefied waste plastic in a pyrolysis zone to produce a pyrolysis effluent stream; (c) separating at least a portion of the pyrolysis effluent stream in a distillation column to thereby recover a pyrolysis oil stream; and (d) combining at least a portion of the pyrolysis oil stream with at least a portion of the liquefied waste plastic in and/or upstream of the pyrolysis zone.

In one aspect, the present technology concerns a chemical recycling process. Generally, the process comprises: (a) liquefying at least a portion of a waste plastic in a liquification system to form a liquefied waste plastic; (b) pyrolyzing at least a portion of the liquefied waste plastic in a pyrolysis zone to produce a pyrolysis effluent stream; (c) separating at least a portion of the pyrolysis effluent stream in a separation system to thereby recover a pyrolysis oil stream; (d) heating at least a portion of the pyrolysis oil stream via indirect heat exchange with at least a portion of the pyrolysis effluent stream to form a heated pyrolysis oil stream; and (e) combining at least a portion of the heated pyrolysis oil stream with at least a portion of the liquefied waste plastic in and/or upstream of the pyrolysis zone.

In one aspect, the present technology concerns a chemical recycling process. Generally, the process comprises: (a) liquefying at least a portion of a waste plastic in a liquification system to form a liquefied waste plastic; (b) pyrolyzing at least a portion of the liquefied waste plastic to produce a pyrolysis effluent stream; and (c) separating at least a portion of the pyrolysis effluent stream in a separation system into a pygas-containing stream having a first mid-boiling point, a pyrolysis oil stream having a second mid-boiling point, and a pyrolysis residue-containing stream having a third mid-boiling point. Generally, the first mid-boiling point is lower than the second mid-boiling point and the second mid-boiling point is lower than the third mid-boiling point. Furthermore, the pyrolyzing of step (b) and the separating of (c) are carried out at a pressure of at least 5 psia.

In one aspect, the present technology concerns a chemical recycling process. Generally, the process comprises: (a) liquefying at least a portion of a waste plastic in a liquification system to form a liquefied waste plastic; (b) pyrolyzing at least a portion of the liquefied waste plastic to produce a pyrolysis effluent stream; (c) separating at least a portion of the pyrolysis effluent stream in a distillation column into a pygas-containing stream, a pyrolysis oil stream, and a pyrolysis residue-containing stream; (d) subjecting at least a portion of the pyrolysis oil stream to the pyrolyzing of step (b); and (e) introducing at least a portion of the pygas-containing stream into a cracking facility.

### BRIEF DESCRIPTION OF THE DRAWINGS

FIG. 1A is a block flow diagram illustrating the initial steps of a process and facility for chemically recycling waste plastic and reutilizing heat from various streams according to embodiments of the present technology;

FIG. 1B is a block flow diagram illustrating the additional steps of a process and facility for chemically recycling waste plastic according to embodiments of the present technology; and

FIG. 2 is a block flow diagram illustrating the main steps of a process and facility for chemically recycling waste plastic and reutilizing heat from the pyrolysis flue gas according to embodiments of the present technology.

### DETAILED DESCRIPTION

We have discovered that heat energy may be captured from various streams in the chemical recycling facility, such as the pyrolysis effluent stream, the pyrolysis oil stream, and/or the pyrolysis flue gas stream, which was previously lost due to process and system inefficiencies. More particularly, we have discovered that heat energy from various streams from a distillation column downstream of the pyrolysis reactor may be utilized to preheat waste plastic streams and provide heat for waste plastic pyrolysis. For example, we have discovered that the heat energy from the pyrolysis effluent stream, the pyrolysis oil stream, and/or the pyrolysis flue gas stream may be used to preheat waste plastic streams and provide heat for waste plastic pyrolysis. Consequently, the pyrolysis processes and systems described herein may obtain a lower carbon footprint by requiring fewer fossil fuels for providing heat to the processes and systems.

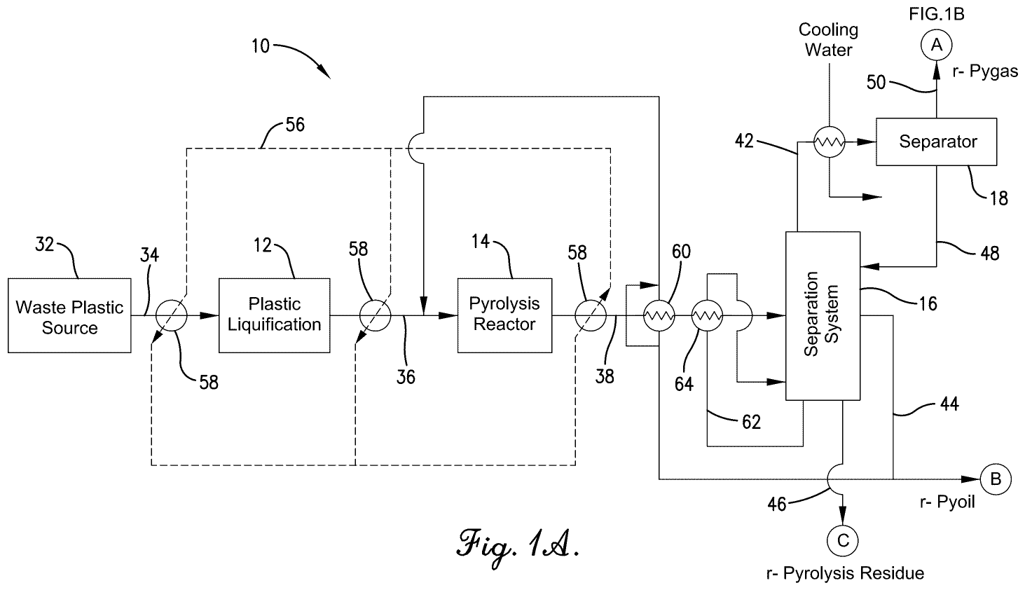

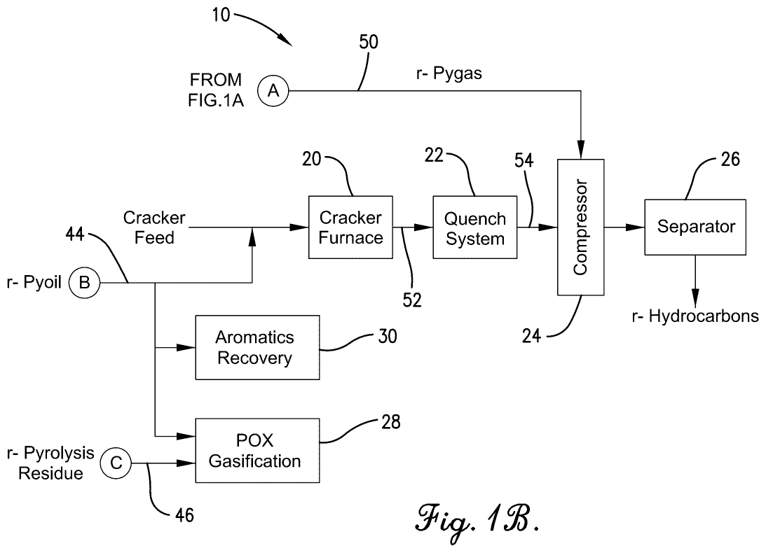

FIGS. 1A and 1B depict an exemplary chemical recycling facility 10 comprising a pyrolysis facility (e.g., the plastic liquification system 12, the pyrolysis reactor 14, the separation system 16, and/or separator 18), a cracking facility (e.g., the cracker furnace 20, the quench system 22, the compression system 24, and the separator 26), a molecular reforming facility (e.g., the POX gasifier 28), and an aromatics recovery facility 30.

As noted above, the chemical recycling facility 10 described herein is able to recover heat energy from a number of different streams formed within the facility, such as the pyrolysis effluent stream, the pyrolysis oil stream, and/or the pyrolysis flue gas. As depicted in FIG. 1A, at least a portion the heat energy from these streams may be used to preheat: (i) the waste plastic prior to the pyrolysis reaction, (ii) the combustion fuel prior to combustion, and/or (iii) the combustion air prior to combustion. It should be understood that FIGS. 1A and 1B depict one exemplary embodiment of the present technology. Certain features depicted in FIGS. 1A and 1B may be omitted and/or additional features described elsewhere herein may be added to the system depicted in FIGS. 1A and 1B. The various process steps are described below in greater detail.

### Overall Chemical Recycling Facility

Turning now to FIGS. 1A and 1B, the main steps of a process for chemically recycling waste plastic in a chemical recycling facility 10 are shown. Chemical recycling processes and facilities as described herein may be used to convert waste plastic to recycle content products or chemical intermediates used to form a variety of end use materials. The waste plastic fed to the chemical recycling facility/process can be mixed plastic waste (MPW), pre-sorted waste plastic, and/or pre-processed waste plastic. As shown in FIG. 1A, the waste plastic feed stream 34 may be derived from the waste plastic source 32, which may include a waste plastic preprocessing facility.

In an embodiment or in combination with any embodiment mentioned herein, the chemical recycling facility 10 may be a commercial-scale facility capable of processing significant volumes of mixed plastic waste. As used herein, the term “commercial scale facility” refers to a facility having an average annual feed rate of at least 500 pounds per hour, averaged over one year.

In an embodiment or in combination with any embodiment mentioned herein, two or more of the facilities shown in FIGS. 1A and 1B, such as the pyrolysis facility (e.g., the pyrolysis reactor 14, the waste plastic source 32, the plastic liquification system 12, the separation system 16, and/or the separator 18), the cracking facility (e.g., the cracker furnace 20, the quench system 22, the compressor system 24, and the separator 26), the molecular reforming facility (e.g., the POX gasifier 28), and the aromatics recovery facility 30 may be co-located with one another. As used herein, the term “co-located” refers to facilities in which at least a portion of the process streams and/or supporting equipment or services are shared between the two facilities. When two or more of the facilities shown in FIGS. 1A and 1B are co-located, the facilities may meet at least one of the following criteria (i) through (v): (i) the facilities share at least one non-residential utility service; (ii) the facilities share at least one service group; (iii) the facilities are owned and/or operated by parties that share at least one property boundary; (iv) the facilities are connected by at least one conduit configured to carry at least one process material (e.g., solid, liquid and/or gas fed to, used by, or generated in a facility) from one facility to another; and (v) the facilities are within 40, within 35, within 30, within 20, within 15, within 12, within 10, within 8, within 5, within 2, or within 1 mile of one another, measured from their geographical center. At least one, at least two, at least three, at least four, or all of the above statements (i) through (v) may be true.

Regarding (i), examples of suitable utility services include, but are not limited to, steam systems (co-generation and distribution systems), cooling water systems, heat transfer fluid systems, plant or instrument air systems, nitrogen systems, hydrogen systems, non-residential electrical generation and distribution, including distribution above 8000V, non-residential wastewater/sewer systems, storage facilities, transport lines, flare systems, and combinations thereof.

Regarding (ii), examples of service groups and facilities include, but are not limited to, emergency services personnel (fire and/or medical), a third-party vendor, a state or local government oversight group, and combinations thereof. Government oversight groups can include, for example, regulatory or environmental agencies, as well as municipal and taxation agencies at the city, county, and state level.

Regarding (iii), the boundary may be, for example, a fence line, a property line, a gate, or common boundaries with at least one boundary of a third-party owned land or facility.

Regarding (iv), the conduit may be a fluid conduit that carries a gas, a liquid, a solid/liquid mixture (e.g., slurry), a solid/gas mixture (e.g., pneumatic conveyance), a solid/liquid/gas mixture, or a solid (e.g., belt conveyance). In some cases, two units may share one or more conduits selected from the above list.

Turning again to FIG. 1A, a stream of waste plastic 34, which can be mixed plastic waste (MPW), may be introduced into the chemical recycling facility 10 from the waste plastic source 32. As used herein, the terms “waste plastic” and “plastic waste” refer to used, scrap, and/or discarded plastic materials, such as plastic materials typically sent to a landfill. The waste plastic stream 34 fed to the chemical recycling facility 10 may include unprocessed or partially processed waste plastic. As used herein, the term “unprocessed waste plastic” means waste plastic that has not be subjected to any automated or mechanized sorting, washing, or comminuting. Examples of unprocessed waste plastic include waste plastic collected from household curbside plastic recycling bins or shared community plastic recycling containers. Partially processed waste plastics may originate from, for example, municipal recycling facilities (MRFs) or reclaimers. In certain embodiments, the waste plastic may comprise at least one of post-industrial (or pre-consumer) plastic and/or post-consumer plastic.

In an embodiment or in combination with any embodiment mentioned herein, the mixed waste plastic (MPW) includes at least two distinct types of plastic.

In an embodiment or in combination with any embodiment mentioned herein, all or a portion of the MPW in the waste plastic stream can originate from a municipal recycling facility (MRF).

In an embodiment or in combination with any embodiment mentioned herein, all or a portion of the MPW in the waste plastic stream can originate from a reclaimer facility.

Examples of suitable waste plastics can include, but are not limited to, polyolefins (PO), aromatic and aliphatic polyesters, polyvinyl chloride (PVC), polystyrene, cellulose esters, polytetrafluoroethylene, acrylobutadienestyrene (ABS), cellulosics, epoxides, polyamides, phenolic resins, polyacetal, polycarbonates, polyphenylene-based alloys, poly(methyl methacrylate), styrene-containing polymers, polyurethane, vinyl-based polymers, styrene acrylonitrile, and urea-containing polymers and melamines.

Examples of specific polyolefins may include linear low-density polyethylene (LLDPE), low density polyethylene (LDPE), polymethylpentene, polybutene-1, high density polyethylene (HDPE), atactic polypropylene, isotactic polypropylene, syndiotactic polypropylene, crosslinked polyethylene, amorphous polyolefins, and the copolymers of any one of the aforementioned polyolefins.

Examples of polyesters can include those having repeating aromatic or cyclic units such as those containing a repeating terephthalate, isophthalate, or naphthalate units such as PET, modified PET, and PEN, or those containing repeating furanate repeating units. As used herein, “PET” or “polyethylene terephthalate” refers to a homopolymer of polyethylene terephthalate, or to a polyethylene terephthalate modified with one or more acid and/or glycol modifiers and/or containing residues or moieties of other than ethylene glycol and terephthalic acid, such as isophthalic acid, 1,4-cyclohexanedicarboxylic acid, diethylene glycol, 2,2,4,4-tetramethyl-1,3-cyclobutanediol (TMCD), cyclohexanedimethanol (CHDM), propylene glycol, isosorbide, 1,4-butanediol, 1,3-propane diol, and/or neopentyl glycol (NPG).

In an embodiment or in combination with any embodiment mentioned herein, the waste plastic stream 34 comprises at least 20, at least 25, at least 30, at least 35, at least 40, at least 45, at least 50, at least 55, at least 60, at least 65, at least 70, at least 75, at least 80, at least 85, at least 90, at least 95, or at least 99 weight percent of one or more polyolefins, based on the total weight of the stream. Alternatively, or in addition, the waste plastic stream comprises not more than 99.9, not more than 99, not more than 97, not more than 92, not more than 90, not more than 85, not more than 80, not more than 75, not more than 70, not more than 65, not more than 60, not more than 55, not more than 50, not more than 45, not more than 40, not more than 35, not more than 30, not more than 25, not more than 20, not more than 15, not more than 10, or not more than 5 weight percent of one or more polyolefins, based on the total weight of the stream.

In one embodiment or in combination with any of the mentioned embodiments, the waste plastic stream 34 comprises not more than 20, not more than 15, not more than 12, not more than 10, not more than 8, not more than 6, not more than 5, not more than 4, not more than 3, not more than 2, or not more than 1 weight percent of polyesters, based on the total weight of the stream.

In one embodiment or in combination with any of the mentioned embodiments, the waste plastic stream 34 comprises not more than 20, not more than 15, not more than 12, not more than 10, not more than 8, not more than 6, not more than 5, not more than 4, not more than 3, not more than 2, or not more than 1 weight percent of biowaste materials, based on the total weight of the stream. As used herein, the term “biowaste” refers to material derived from living organisms or of organic origin. Exemplary biowaste materials include, but are not limited to, cotton, wood, saw dust, food scraps, animals and animal parts, plants and plant parts, and manure.

In an embodiment or in combination with any embodiment mentioned herein, the waste plastic stream 34 can include not more than 10, not more than 5, not more than 4, not more than 3, not more than 2, not more than 1, not more than 0.75, or not more than 0.5 weight percent of polyvinyl chloride (PVC), based on the total weight of the stream.

The general configuration and operation of each of the facilities that may be present in the chemical recycling facility 10 shown in FIGS. 1A and 1B will now be described in further detail below, beginning with the optional preprocessing facility of the waste plastic source 32.

### Optional Plastic Preprocessing

As shown in FIG. 1A, unprocessed, partially processed, and/or processed waste plastic, such as mixed plastic waste (MPW), may first be introduced into the chemical recycling facility 10 via the waste plastic stream 34 from the waste plastic source 32. As noted above, the waste plastic source 32 may include an optional preprocessing facility that can prepare the waste plastic feedstock for the downstream recycling processes. While in the optional preprocessing facility, the waste plastic feedstock may undergo one or more preprocessing steps to prepare it for chemical recycling. As used herein, the term “preprocessing facility” refers to a facility that includes all equipment, lines, and controls necessary to carry out the preprocessing of waste plastic. Preprocessing facilities as described herein may employ any suitable method for carrying out the preparation of waste plastic for chemical recycling using one or more of following steps, which are described in further detail below. Alternatively, in certain embodiments, the waste plastic source 32 does not contain a preprocessing facility and the waste plastic stream 34 is not subjected to any preprocessing before any of the downstream chemical recycling steps described herein.

In an embodiment or in combination with any embodiment mentioned herein, the preprocessing facility of the waste plastic source 32 may include at least one separation step or zone. The separation step or zone may be configured to separate the waste plastic stream 34 into two or more streams enriched in certain types of plastics. Such separation is particularly advantageous when the waste plastic fed to the chemical recycling facility 10 is MWP.

Any suitable type of separation device, system, or facility may be employed to separate the waste plastic into two or more streams enriched in certain types of plastics such as, for example, a PET-enriched stream and a PO-enriched stream. Examples of suitable types of separation include mechanical separation and density separation, which may include sink-float separation and/or centrifugal density separation. As used herein, the term “sink-float separation” refers to a density separation process where the separation of materials is primarily caused by floating or sinking in a selected liquid medium, while the term “centrifugal density separation” refers to a density separation process where the separation of materials is primarily caused by centrifugal forces.

Referring again to FIG. 1A, the waste plastic stream 34 may be introduced into one or more downstream processing facilities (or undergo one or more downstream processing steps) within the chemical recycling facility 10. In an embodiment or in combination with any embodiment mentioned herein, at least a portion of the waste plastic stream 34 may be directly or indirectly introduced into a plastic liquification system 12 within the waste plastic source 32 or outside of it. Additional details of each step, as well as the general integration of each of these steps or facilities with one or more of the others according to one or more embodiments of the present technology are discussed in further detail below.

### Liquification/Dehalogenation

As shown in FIG. 1A, the waste plastic stream 34 may be introduced into a plastic liquification system 12 prior to being introduced into the pyrolysis reactor 14. As used herein, the term “liquification” system refers to a chemical processing zone or step in which at least a portion of the incoming plastic is liquefied. The step of liquefying plastic in FIG. 1A can include chemical liquification, physical liquification, or combinations thereof. Exemplary methods of liquefying the plastic introduced in the liquification system 12 can include: (i) heating/melting; (ii) dissolving in a solvent; (iii) depolymerizing; (iv) plasticizing; and combinations thereof. Additionally, one or more of options (i) through (iv) may also be accompanied by the addition of a blending or liquification agent to help facilitate the liquification (reduction of viscosity) of the polymer material. As such, a variety of rheology modification agents (e.g., solvents, depolymerization agents, plasticizers, and blending agents) can be used the enhance the flow and/or dispersibility of the liquified waste plastic.

When added to the liquification system 12, at least 50, at least 55, at least 60, at least 65, at least 70, at least 75, at least 80, at least 85, at least 90, at least 95, or at least 99 weight percent of the plastic (usually waste plastic) originally present in the waste plastic stream 34 undergoes a reduction in viscosity. In some cases, the reduction in viscosity can be facilitated by heating (e.g., addition of steam directly or indirectly contacting the plastic), while, in other cases, it can be facilitated by combining the plastic with a solvent capable of dissolving it. Examples of suitable solvents can include, but are not limited to, alcohols such as methanol or ethanol, glycols such as ethylene glycol, diethylene glycol, triethylene glycol, neopentyl glycol, cyclohexanedimethanol, glycerin, pyrolysis oil, motor oil, and water. This dissolution solvent can be added directly to the liquification vessel in the liquification system 12, or it can be previously combined with one or more streams fed to the liquification system 12, including the waste plastic stream 34.

In an embodiment or in combination with any embodiment mentioned herein, the dissolution solvent can comprise a stream withdrawn from one or more other facilities within the chemical recycling facility 10. For example, the solvent can comprise a stream withdrawn from the pyrolysis reactor 14 and/or the separation zone. In certain embodiments, the dissolution solvent can be or comprise pyrolysis oil.

In some cases, the waste plastic can be depolymerized such that, for example, the number average chain length of the plastic is reduced by contact with a depolymerization agent. In an embodiment or in combination with any embodiment mentioned herein, at least one of the previously-listed solvents may be used as a depolymerization agent, while, in one or more other embodiments, the depolymerization agent can include an organic acid (e.g., acetic acid, citric acid, butyric acid, formic acid, lactic acid, oleic acid, oxalic, stearic acid, tartaric acid, and/or uric acid) or inorganic acid such as sulfuric acid (for polyolefins). The depolymerization agent may reduce the melting point and/or viscosity of the polymer by reducing its number average chain length.

Alternatively, or additionally, a plasticizer can be used in the liquification system 12 to reduce the viscosity of the plastic. Plasticizers for polyethylene include, for example, dioctyl phthalate, dioctyl terephthalate, glyceryl tribenzoate, polyethylene glycol having molecular weight of up to 8,000 Daltons, sunflower oil, paraffin wax having molecular weight from 400 to 1,000 Daltons, paraffinic oil, mineral oil, glycerin, EPDM, and EVA. Plasticizers for polypropylene include, for example, dioctyl sebacate, paraffinic oil, isooctyl tallate, plasticizing oil (Drakeol 34), naphthenic and aromatic processing oils, and glycerin. Plasticizers for polyesters include, for example, polyalkylene ethers (e.g., polyethylene glycol, polytetramethylene glycol, polypropylene glycol or their mixtures) having molecular weight in the range from 400 to 1500 Daltons, glyceryl monostearate, octyl epoxy soyate, epoxidized soybean oil, epoxy tallate, epoxidized linseed oil, polyhydroxyalkanoate, glycols (e.g., ethylene glycol, pentamethylene glycol, hexamethylene glycol, etc.), phthalates, terephthalates, trimellitate, and polyethylene glycol di-(2-ethylhexoate). When used, the plasticizer may be present in an amount of at least 0.1, at least 0.5, at least 1, at least 2, or at least 5 weight percent and/or not more than 10, not more than 8, not more than 5, not more than 3, not more than 2, or not more than 1 weight percent, based on the total weight of the waste plastic stream 34, or it can be in a range of from 0.1 to 10 weight percent, 0.5 to 8 weight percent, or 1 to 5 weight percent, based on the total weight of the waste plastic stream 34.

Further, one or more of the methods of liquefying the waste plastic stream 34 can also include adding at least one blending agent to the plastic stream before, during, or after the liquification process in the liquification system 12. Such blending agents may include for example, emulsifiers and/or surfactants, and may serve to more fully blend the liquified plastic into a single phase, particularly when differences in densities between the plastic components of a mixed plastic stream result in multiple liquid or semi-liquid phases. When used, the blending agent may be present in an amount of at least 0.1, at least 0.5, at least 1, at least 2, or at least 5 weight percent and/or not more than 10, not more than 8, not more than 5, not more than 3, not more than 2, or not more than 1 weight percent, based on the total weight of the waste plastic stream 34, or it can be in a range of from 0.1 to 10 weight percent, 0.5 to 8 weight percent, or 1 to 5 weight percent, based on the total weight of the waste plastic stream 34.

In an embodiment or in combination with any embodiment mentioned herein, and as discussed below, a portion of the pyrolysis oil stream can be combined with the waste plastic stream 34 to form a liquified plastic. Generally, in such embodiments, all or a portion of the pyrolysis oil stream may be combined with the waste plastic stream 34 prior to introduction into the liquification system 12, or after the waste plastic stream 34 enters the liquification vessel within the liquification system 12.

In an embodiment or in combination with any embodiment mentioned herein, the liquified (or reduced viscosity) plastic stream withdrawn from the liquification system 12 can include at least 1, at least 5, at least 10, at least 15, at least 20, at least 25, at least 30, at least 35, at least 40, at least 45, at least 50, at least 55, at least 60, at least 65, at least 70, at least 75, at least 80, at least 85, at least 90, at least 95, or at least 99 weight percent and/or not more than 95, not more than 90, not more than 85, not more than 80, not more than 75, not more than 70, not more than 65, not more than 60, not more than 55, not more than 50, not more than 45, not more than 40, not more than 35, not more than 30, not more than 25, not more than 20, not more than 15, not more than 10, not more than 5, not more than 2, or not more than 1 weight percent of one or more polyolefins, based on the total weight of the stream, or the amount of polyolefins can be in the range of from 1 to 99 weight percent, 5 to 90 weight percent, or 10 to 85 weight percent, based on the total weight of the stream.

In an embodiment or in combination with any embodiment mentioned herein, the liquified plastic stream 36 exiting the plastic liquification system 12 can have a viscosity of less than 3,000, less than 2,500, less than 2,000, less than 1,500, less than 1,000, less than 800, less than 750, less than 700, less than 650, less than 600, less than 550, less than 500, less than 450, less than 400, less than 350, less than 300, less than 250, less than 150, less than 100, less than 75, less than 50, less than 25, less than 10, less than 5, or less than 1 poise, as measured using a Brookfield R/S rheometer with a V80-40 vane spindle operating at a shear rate of 10 rad/s and a temperature of 350° C.

In an embodiment or in combination with any embodiment mentioned herein, the plastic liquification system 12 may comprise at least one liquification vessel to facilitate the liquefying of the waste plastics. In various embodiments, the liquification vessel can include at least one melt tank and/or at least one extruder to facilitate the plastic liquification. Additionally, in certain embodiments, the liquification system 12 may also contain at least one stripping column and at least one disengagement vessel to facilitate the removal of halogenated compounds that may be formed in the liquification vessel.

In an embodiment or in combination with any embodiment mentioned herein, the melt tank can include one or more continuously stirred tanks. When one or more rheology modification agents (e.g., solvents, depolymerization agents, plasticizers, and blending agents) are used in the liquification system 12, such rheology modification agents can be added to and/or mixed with the waste plastic stream 34 in or prior to introduction into the melt tank.

In an embodiment or in combination with any embodiment mentioned herein, the liquification vessel, such as the melt tank and/or the extruder, may receive the waste plastic feed stream 34 and heat the waste plastic via heating mechanisms in the melt tank and/or via the extrusion process in the extruder.

In an embodiment or in combination with any embodiment mentioned herein, the interior space of the liquification vessel, where the plastic is heated, is maintained at a temperature of at least 200, at least 210, at least 220, at least 230, at least 240, at least 250, at least 260, at least 270, at least 280, at least 290, at least 300, at least 310, at least 320, at least 330, at least 340, at least 350, at least 360, at least 370, at least 380, at least 390, or at least 400° C. Additionally, or in the alternative, the interior space of the liquification vessel may be maintained at a temperature of not more than 500, not more than 475, not more than 450, not more than 425, not more than 400, not more than 390, not more than 380, not more than 370, not more than 365, not more than 360, not more than 355, not more than 350, or not more than 345° C. Generally, in one or more embodiments, the interior space of the liquification vessel may be maintained at a temperature ranging from 200 to 500° C., 240 to 425° C., 280 to 380° C., or 320 to 350° C.

In an embodiment or in combination with any embodiment mentioned herein, the liquification system 12 may optionally contain equipment for removing halogens from the waste plastic stream 34. When the waste plastic is heated in the liquification system 12, halogen enriched gases can evolve. By disengaging the evolved halogen-enriched gasses from the liquified plastics, the concentration of halogens in the liquified plastic stream 36 can be reduced.

In an embodiment or in combination with any embodiment mentioned herein, dehalogenation can be promoted by sparging a stripping gas (e.g., steam) into the liquified plastics in the melt tank.

In an embodiment or in combination with any embodiment mentioned herein, the liquified plastic stream 36 exiting the liquification system 12 can have a halogen content of less than 500, less than 400, less than 300, less than 200, less than 100, less than 50, less than 10, less than 5, less than 2, less than 1, less than 0.5, or less than 0.1 ppmw.

In an embodiment or in combination with any embodiment mentioned herein, the halogen content of the liquified plastic stream 36 exiting the liquification system 12 can be not more than 95, not more than 90, not more than 75, not more than 50, not more than 25, not more than 10, or not more than 5 percent by weight of the halogen content of the waste plastic stream 34 introduced into the liquification system 12.

In an embodiment or in combination with any embodiment mentioned herein, the liquefied waste plastic stream 34 exiting the plastic liquification system 12 may have a temperature of at least 200, at least 225, at least 250, at least 275, at least 300, at least 310, at least 320, at least 330, or at least 340° C. and/or less than 450, less than 425, less than 400, less than 375, or less than 350° C.

As shown in FIG. 1A and described below in greater detail, at least a portion of the liquified plastic stream 36 may be introduced into a downstream pyrolysis reactor 14 at a pyrolysis facility to produce a pyrolysis effluent 38, including a pyrolysis oil and a pyrolysis gas.

### Pyrolysis

As shown in FIG. 1A, the chemical recycling facility 10 may comprise a pyrolysis reactor 14. As used herein, the term “pyrolysis” refers to thermal decomposition of a feedstock of a biomass and/or a plastic material in solid or liquid form at elevated temperatures in an inert (i.e., substantially molecular oxygen free) atmosphere. A “pyrolysis facility” is a facility that includes all equipment, lines, and controls necessary to carry out pyrolysis of waste plastic and feedstocks derived therefrom. In certain embodiments, the pyrolysis facility can comprise the pyrolysis reactor 14 and, optionally, the plastic liquification system 12, the waste plastic source 32, the separation system 16, and/or the separator 18 depicted in FIG. 1A.

As depicted in FIG. 1A, the liquified plastic stream 36 may be introduced into a downstream pyrolysis reactor 14 at a pyrolysis facility so as to produce a pyrolysis effluent stream 38 comprising a pyrolysis oil, a pyrolysis gas, and a pyrolysis residue.

In an embodiment or in combination with any embodiment mentioned herein, the liquified plastic stream 36 to the pyrolysis facility may be a PO-enriched stream of waste plastic. The liquified plastic stream 36 introduced into the pyrolysis reactor 14 can be in the form of liquified plastic (e.g., liquified, melted, plasticized, depolymerized, or combinations thereof), plastic pellets or particulates, or a slurry thereof.

In general, the pyrolysis facility may include: (i) the plastic liquification system 12, (ii) the pyrolysis reactor 14, (iii) a separation system 16 (e.g., a distillation column) for the pyrolysis effluent, which can separate the pyrolysis effluent into a pyrolysis gas stream, a pyrolysis oil stream, and/or a pyrolysis residue stream, and (iv) a separator 18 for the pyrolysis vapors.

While in the pyrolysis reactor 14, at least a portion of the feed may be subjected to a pyrolysis reaction that produces a pyrolysis effluent comprising a pyrolysis oil, a pyrolysis gas, and a pyrolysis residue. Generally, the pyrolysis effluent stream 38 exiting the pyrolysis reactor 14 can be in the form of pyrolysis vapors that comprise the pyrolysis gas and uncondensed pyrolysis oil. As used herein, “pyrolysis vapor” refers to the uncondensed pyrolysis effluent that comprises the majority of the pyrolysis oil and the pyrolysis gas present in the pyrolysis effluent.

Pyrolysis is a process that involves the chemical and thermal decomposition of the introduced feed. Although all pyrolysis processes may be generally characterized by a reaction environment that is substantially free of oxygen, pyrolysis processes may be further defined, for example, by the pyrolysis reaction temperature within the reactor, the residence time in the pyrolysis reactor 14, the reactor type, the pressure within the pyrolysis reactor 14, and the presence or absence of pyrolysis catalysts.

In an embodiment or in combination with any embodiment mentioned herein, the pyrolysis reactor 14 can be, for example, a film reactor, a screw extruder, a tubular reactor, a tank, a stirred tank reactor, a riser reactor, a fixed bed reactor, a fluidized bed reactor, a rotary kiln, a vacuum reactor, a microwave reactor, or an autoclave. In various embodiments, the pyrolysis reactor 14 may comprise a tubular reactor.

In an embodiment or in combination with any embodiment mentioned herein, a lift gas and/or a feed gas may be used to introduce the feedstock into the pyrolysis reactor 14 and/or facilitate various reactions within the pyrolysis reactor 14. For instance, the lift gas and/or the feed gas may comprise, consist essentially of, or consist of nitrogen, carbon dioxide, and/or steam. The lift gas and/or feed gas may be added with the waste plastic stream 34 prior to introduction into the pyrolysis reactor 14 and/or may be added directly to the pyrolysis reactor 14. The lift gas and/or feed gas can include steam and/or a reducing gas such as hydrogen, carbon monoxide, and combinations thereof.

Furthermore, the temperature in the pyrolysis reactor 14 can be adjusted so as to facilitate the production of certain end products. In an embodiment or in combination with any embodiment mentioned herein, the pyrolysis temperature in the pyrolysis reactor 14 can range from 325 to 1,100° C., 350 to 900° C., 350 to 700° C., 350 to 550° C., 350 to 475° C., 425 to 1,100° C., 425 to 800° C., 500 to 1,100° C., 500 to 800° C., 600 to 1,100° C., 600 to 800° C., 625 to 1,000° C., 700 to 1,000° C., or 625 to 800° C. Generally, in certain embodiments, the pyrolysis temperature in the pyrolysis reactor 14 can be greater than 625° C.

In an embodiment or in combination with any embodiment mentioned herein, the residence times of the feedstocks within the pyrolysis reactor 14 can be at least 0.1, at least 0.2, at least 0.3, at least 0.5, at least 1, at least 1.2, at least 1.3, at least 2, at least 3, or at least 4 seconds. Alternatively, the residence times of the feedstocks within the pyrolysis reactor 14 can be at least 1, at least 2, at least 3, at least 4, at least 5, at least 6, at least 7, at least 8, at least 9, at least 10, at least 20, at least 30, at least 45, at least 60, at least 75, or at least 90 minutes. Additionally, or alternatively, the residence times of the feedstocks within the pyrolysis reactor 14 can be less than 6, less than 5, less than 4, less than 3, less than 2, less than 1, or less than 0.5 hours. Furthermore, the residence times of the feedstocks within the pyrolysis reactor 14 can be less than 100, less than 90, less than 80, less than 70, less than 60, less than 50, less than 40, less than 30, less than 20, less than 10, less than 9, less than 8, less than 7, less than 6, less than 5, less than 4, less than 3, less than 2, or less than 1 seconds. More particularly, the residence times of the feedstocks within the pyrolysis reactor 14 can range from 0.1 to 10 seconds, 0.5 to 10 seconds, 30 minutes to 4 hours, or 30 minutes to 3 hours, or 1 hour to 3 hours, or 1 hour to 2 hours.

In an embodiment or in combination with any embodiment mentioned herein, the pressure within the pyrolysis reactor 14 can be maintained at a pressure of at least 5, at least 8, at least 12, at least 15, at least 20, at least 30, or at least 45 psia. Additionally, or alternatively, the pressure within the pyrolysis reactor 14 can be maintained at a pressure of not more than 300, not more than 200, or not more than 100 psia.

In an embodiment or in combination with any embodiment mentioned herein, a pyrolysis catalyst may be introduced into the liquified plastic stream 36 prior to introduction into the pyrolysis reactor 14 and/or introduced directly into the pyrolysis reactor 14. The catalyst can be homogenous or heterogeneous and may include, for example, certain types of zeolites and other mesostructured catalysts.

In an embodiment or in combination with any embodiment mentioned herein, the pyrolysis reaction may not be catalyzed (e.g., carried out in the absence of a pyrolysis catalyst), but may include a non-catalytic, heat-retaining inert additive, such as sand, in the reactor in order to facilitate the heat transfer. Such catalyst-free pyrolysis processes may be referred to as “thermal pyrolysis.”

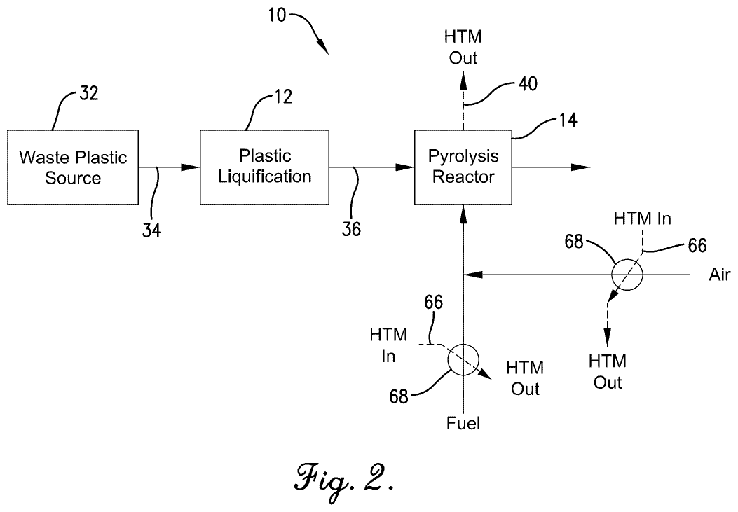

In an embodiment or in combination with any embodiment mentioned herein, the pyrolysis reactor 14 may be at least partially heated by a combustion system comprising a plurality a burners (not depicted) that combust a combustion fuel and a combustion air, as shown in FIG. 2. Furthermore, as depicted in FIG. 2, this combustion system may produce a flue gas stream 40 that can be removed from the pyrolysis reactor 14. The combustion fuel may comprise a conventional fossil fuel and/or a recycle content fuel, such as recycle content alkanes (e.g., r-methane) and/or recycle content hydrogen derived from the chemical recycling facility 10.

Turning again to FIG. 1A, after exiting the pyrolysis reactor 14, at least a portion of the pyrolysis effluent 38 may be introduced into a separation system 16, such as a distillation column, and separated into a pyrolysis vapor stream 42 (i.e., a pygas-containing stream), a pyrolysis oil stream 44, and a pyrolysis residue stream 46. Although not depicted in FIG. 1A, this separation system 16 can include various types of equipment including, but not limited to a filter system, a multistage separator, a condensation zone, a distillation column, and/or a quench tower. Generally, the separation system 16 comprises one or more distillation columns. While in the distillation column, the pyrolysis effluent may be separated into the pyrolysis vapor stream 42, the pyrolysis oil stream 44, and the pyrolysis residue stream 46. The distillation columns can include any conventional distillation column known in the art and may comprise a plurality of stacked plates. For instance, the distillation column may comprise a conventional fractionating column used in the art.

In an embodiment or in combination with any embodiment mentioned herein, the pressure within the distillation column can be maintained at a pressure of at least 5, at least 8, at least 12, at least 15, at least 20, at least 30, or at least 45 psia. Additionally, or alternatively, the pressure within the distillation column can be maintained at a pressure of not more than 300, not more than 200, or not more than 100 psia.

As shown in FIG. 1A, at least a portion of the pyrolysis vapors stream 42 exiting the overhead of the separation system 16 (e.g., a distillation column) may be introduced into a downstream separator 18 so as to separate the pyrolysis vapor stream into a pyrolysis gas stream, which is enriched in C1-C4 hydrocarbons relative to the pyrolysis vapor stream, and an enriched C5+ hydrocarbon stream 48, which is enriched in C5+ hydrocarbons relative to the pyrolysis vapors stream. As used herein, “C5+ hydrocarbons” refers to hydrocarbon compounds containing at least 5 total carbons per molecule, and encompasses all olefins, paraffins, and isomers having that number of carbon atoms. Optionally, as shown in FIG. 1A, the pyrolysis vapors stream 42 can be subjected to cooling via indirect heat exchange with a cooling water prior to further to separation in the separator 18.

Although not depicted in FIG. 1A, this separator 18 can include various types of equipment including, but not limited to a filter system, a multistage separator, a condensation zone, a distillation column, and/or a quench tower. While in the separator 18, the pyrolysis vapor stream 42 may be cooled to thereby condense at least a portion of the pyrolysis oil fraction originally present in the pyrolysis vapor stream 42. After leaving the separator 18, at least a portion of the condensed enriched C5+ hydrocarbon stream 48 may be reintroduced into the separation system 16 (e.g., the distillation column) to further separate and purify the stream, along with the pyrolysis effluent stream 38. The resulting pyrolysis gas stream 50 may be subjected to further processing, as described below in regard to FIG. 1B.

In an embodiment or in combination with any embodiment mentioned herein, the pyrolysis effluent or pyrolysis vapors from the pyrolysis reactor 14 may comprise at least 1, at least 5, at least 10, at least 15, at least 20, at least 25, at least 30, at least 35, at least 40, at least 45, at least 50, at least 55, at least 60, at least 65, at least 70, or at least 75 weight percent of the pyrolysis oil, based on the total weight of the pyrolysis effluent or pyrolysis vapors. Additionally, or alternatively, the pyrolysis effluent or pyrolysis vapors may comprise not more than 99, not more than 95, not more than 90, not more than 85, not more than 80, not more than 75, not more than 70, not more than 65, not more than 60, not more than 55, not more than 50, not more than 45, not more than 40, not more than 35, not more than 30, or not more than 25 weight percent of the pyrolysis oil, based on the total weight of the pyrolysis effluent or pyrolysis vapors. As discussed above, the pyrolysis oil may be in the form of uncondensed vapors in the pyrolysis effluent upon exiting the heated reactor; however, these vapors may be subsequently condensed into the resulting pyrolysis oil. The pyrolysis effluent or pyrolysis vapors may comprise in the range of 20 to 99 weight percent, 25 to 80 weight percent, 30 to 85 weight percent, 30 to 80 weight percent, 30 to 75 weight percent, 30 to 70 weight percent, or 30 to 65 weight percent of the pyrolysis oil, based on the total weight of the pyrolysis effluent or pyrolysis vapors.

In an embodiment or in combination with any embodiment mentioned herein, the pyrolysis effluent or pyrolysis vapors from the pyrolysis reactor 14 may comprise at least 1, at least 5, at least 10, at least 15, at least 20, at least 25, at least 30, at least 35, at least 40, at least 45, at least 50, at least 55, at least 60, at least 65, at least 70, at least 75, or at least 80 weight percent of the pyrolysis gas, based on the total weight of the pyrolysis effluent or pyrolysis vapors. Additionally, or alternatively, the pyrolysis effluent or pyrolysis vapors may comprise not more than 99, not more than 95, not more than 90, not more than 85, not more than 80, not more than 75, not more than 70, not more than 65, not more than 60, not more than 55, not more than 50, or not more than 45 weight percent of the pyrolysis gas, based on the total weight of the pyrolysis effluent or pyrolysis vapors. The pyrolysis effluent may comprise 1 to 90 weight percent, 10 to 85 weight percent, 15 to 85 weight percent, 20 to 80 weight percent, 25 to 80 weight percent, 30 to 75 weight percent, or 35 to 75 weight percent of the pyrolysis gas, based on the total weight of the stream.

In an embodiment or in combination with any embodiment mentioned herein, the pyrolysis effluent or pyrolysis vapors from the pyrolysis reactor 14 may comprise at least 0.5, at least 1, at least 2, at least 3, at least 4, at least 5, at least 6, at least 7, at least 8, at least 9, or at least 10 weight percent of the pyrolysis residue, based on the total weight of the pyrolysis effluent or pyrolysis vapors. Additionally, or alternatively, the pyrolysis effluent may comprise not more than 60, not more than 50, not more than 40, not more than 30, not more than 25, not more than 20, not more than 15, not more than 10, not more than 9, not more than 8, not more than 7, not more than 6, or not more than 5 weight percent of the pyrolysis residue, based on the total weight of the pyrolysis effluent or pyrolysis vapors. The pyrolysis effluent may comprise in the range of 0.1 to 25 weight percent, 1 to 15 weight percent, 1 to 8 weight percent, or 1 to 5 weight percent of the pyrolysis residue, based on the total weight of the pyrolysis effluent or pyrolysis vapors. This pyrolysis residue may be removed from the pyrolysis reactor 14 (where it may form) and/or separated from the pyrolysis effluent in a downstream separator, such as the distillation column.

In an embodiment or in combination with any embodiment mentioned herein, the weight ratio of the pyrolysis gas stream 50 to the pyrolysis oil stream 44 formed by the pyrolysis facility can be at least 0.2:1, 0.5:1, 1:1, 2:1, or 3:1. Additionally, or in the alternative, C/(A+B) is less than 0.2, less than 0.1, less than 0.05, or less than 0.01, where C is the total weight of the pyrolysis residue stream, A is the total weight of the pyrolysis gas stream, and B is the total weight of the pyrolysis oil stream.

The resulting pyrolysis oil stream and pyrolysis gas stream may be directly used in various downstream applications based on their formulations. The various characteristics and properties of the pyrolysis effluent stream 38, the enriched C5+ hydrocarbon stream 48, the pyrolysis oil stream 44, the pyrolysis gas stream 50, and the pyrolysis residue stream 46 are described below. It should be noted that, while all of the following characteristics and properties may be listed separately, it is envisioned that each of the following characteristics and/or properties of the pyrolysis effluent stream 38, the enriched C5+ hydrocarbon stream 48, the pyrolysis oil stream 44, the pyrolysis gas stream 50, and the pyrolysis residue stream 46 are not mutually exclusive and may be combined and present in any combination.

In an embodiment or in combination with any embodiment mentioned herein, the pyrolysis effluent stream 38 from the pyrolysis reactor 14 may comprise at least 40, at least 45, at least 50, at least 55, at least 60, at least 65, at least 70, at least 75, at least 80, at least 85, at least 90, or at least 95 weight percent of C1 to C4 hydrocarbons, based on the total weight of the pyrolysis effluent stream. As used herein, the term “Cx” or “Cx hydrocarbon,” refers to a hydrocarbon compound including “x” total carbons per molecule, and encompasses all olefins, paraffins, aromatics, heterocyclic, and isomers having that number of carbon atoms. For example, each of normal, iso, and tert-butane and butene and butadiene molecules would fall under the general description “C4.”

In an embodiment or in combination with any embodiment mentioned herein, the pyrolysis oil stream 44 may predominantly comprise hydrocarbons having from 4 to 30 carbon atoms per molecule (e.g., C4 to C30 hydrocarbons). The pyrolysis oil may have a C4-C30 hydrocarbon content of at least 55, at least 60, at least 65, at least 70, at least 75, at least 80, at least 85, at least 90, or at least 95 weight percent based on the total weight of the pyrolysis oil stream.

In an embodiment or in combination with any embodiment mentioned herein, the pyrolysis oil stream 44 can predominantly comprise C5 to C25 hydrocarbons, C5 to C22 hydrocarbons, C5 to C20 hydrocarbons, or C5 to C14 hydrocarbons. For example, the pyrolysis oil may comprise at least 50, at least 55, at least 60, at least 65, at least 70, at least 75, at least 80, at least 85, at least 90, or at least 95 weight percent of C5 to C25 hydrocarbons, C5 to C22 hydrocarbons, C5 to C20 hydrocarbons, or C5 to C14 hydrocarbons, based on the total weight of the pyrolysis oil stream.

In an embodiment or in combination with any embodiment mentioned herein, the pyrolysis oil 44 may have a mid-boiling point in the range of 75 to 250° C., 90 to 225° C., or 115 to 190° C. as measured according to ASTM D-5399. As used herein, “mid-boiling point” refers to the median boiling point temperature of the pyrolysis oil, where 50 percent by volume of the pyrolysis oil boils above the mid-boiling point and 50 percent by volume boils below the mid-boiling point. Generally, in various embodiments, the pyrolysis gas stream will have the lowest mid-boiling point, followed by the pyrolysis oil stream, and then the pyrolysis residue stream will have the highest mid-boiling point.

In an embodiment or in combination with any embodiment mentioned herein, the boiling point range of the pyrolysis oil 44 may be such that at least 90 percent of the pyrolysis oil boils off at a temperature of 250° C., of 280° C., of 290° C., of 300° C., or of 310° C., as measured according to ASTM D-5399.

In an embodiment or in combination with any embodiment mentioned herein, the enriched C5+ hydrocarbon stream 48 can predominantly comprise C5 to C25 hydrocarbons, C5 to C22 hydrocarbons, C5 to C20 hydrocarbons, or C5 to C14 hydrocarbons. For example, the enriched C5+ hydrocarbon stream may comprise at least 50, at least 55, at least 60, at least 65, at least 70, at least 75, at least 80, at least 85, at least 90, or at least 95 weight percent of C5 to C25 hydrocarbons, C5 to C22 hydrocarbons, C5 to C20 hydrocarbons, or C5 to C14 hydrocarbons, based on the total weight of the stream.

As noted above, the pyrolysis conditions, such as temperature, may be controlled so as to maximize the production of certain hydrocarbons and chemical compounds in the resulting pyrolysis gas and pyrolysis oil.

Turning to the pyrolysis gas, the pyrolysis gas stream 50 can have a methane content in the range of 1 to 50 weight percent, 5 to 50 weight percent, or 15 to 45 weight percent, based on the total weight of the pyrolysis gas stream.

In an embodiment or in combination with any embodiment mentioned herein, the pyrolysis gas stream 50 can have a C3 and/or C4 hydrocarbon content (including all hydrocarbons having 3 or 4 carbon atoms per molecule) in the range of 10 to 90 weight percent, 25 to 90 weight percent, or 25 to 80 weight percent, based on the total weight of the pyrolysis gas stream.

In an embodiment or in combination with any embodiment mentioned herein, the pyrolysis gas stream 50 can have a combined ethylene and propylene content of at least 25, at least 40, at least 50, at least 60, at least 70, or at least 75 weight percent, based on the total weight of the pyrolysis gas stream.

In an embodiment or in combination with any embodiment mentioned herein, the pyrolysis gas stream 50 may comprise at least 50, at least 55, at least 60, at least 65, at least 70, at least 75, at least 80, at least 85, at least 90, or at least 95 weight percent of C1 to C4 hydrocarbons, based on the total weight of the pyrolysis gas stream.

Turning to the pyrolysis residue 46, in an embodiment or in combination with any embodiment mentioned herein, the pyrolysis residue stream comprises at least 20, at least 25, at least 30, at least 35, at least 40, at least 45, at least 50, at least 55, at least 60, at least 65, at least 70, at least 75, at least 80, or at least 85 weight percent of C20+ hydrocarbons based on the total weight of the pyrolysis residue. As used herein, “C20+ hydrocarbon” refers to hydrocarbon compounds containing at least 20 total carbons per molecule, and encompasses all olefins, paraffins, and isomers having that number of carbon atoms.

In an embodiment or in combination with any embodiment mentioned herein, the pyrolysis residue stream 46 comprises at least 20, at least 25, at least 30, at least 35, at least 40, at least 45, at least 50, at least 55, at least 60, at least 65, at least 70, at least 75, at least 80, at least 85, at least 90, or at least 95 weight percent of C15+ hydrocarbons based on the total weight of the pyrolysis residue. As used herein, “C15+ hydrocarbon” refers to hydrocarbon compounds containing at least 15 total carbons per molecule, and encompasses all olefins, paraffins, and isomers having that number of carbon atoms.

As shown in FIG. 1B, at least a portion of the pyrolysis effluent, such as the pyrolysis gas stream 50, the pyrolysis oil steam 44, and/or the pyrolysis residue stream 46, may be routed to one or more other chemical processing facilities, including, for example, the cracking facility, the molecular reforming facility (e.g., a POX gasifier 28), and/or an aromatics recovery facility 30.

### Cracking

As shown in FIG. 1B, at least a portion of one or more streams from the pyrolysis facility, including the pyrolysis oil stream 44 and/or the pyrolysis gas stream 50, may be introduced into a cracking facility. As used herein, the term “cracking” refers to breaking down complex organic molecules into simpler molecules by the breaking of carbon-carbon bonds. A “cracking facility” is a facility that includes all equipment, lines, and controls necessary to carry out cracking of a feedstock derived from waste plastic. A cracking facility can include one or more cracker furnaces 20, a quench system 22 for cooling the cracked products, a compression system 24, and a downstream separation zone 26 including equipment used to process the effluent of the cracker furnace(s) 20. As used herein, the terms “cracker” and “cracking” are used interchangeably.

In general, the cracker facility may include a cracker furnace 20, a quench system 22, a compression system 24, and a separation zone 26 downstream of the cracker furnace 20 for separating the furnace effluent into various end products, such as a recycle content hydrocarbons (r-hydrocarbons) stream. In an embodiment or in combination with any embodiment mentioned herein, at least a portion of the pyrolysis oil stream 44 and/or the pyrolysis gas stream 50 can be sent to the cracking facility. The pyrolysis oil stream 44 may be introduced into an inlet of the cracker furnace 20, while the pyrolysis gas stream 50 can be introduced into a location upstream or downstream of the furnace 20. The effluent from the cracker furnace 20 may be separated into various recycle content products in the downstream separator 26, as shown in FIG. 1B. When used, the pyrolysis oil stream 44 and/or pyrolysis gas stream 50 may optionally be combined with a stream of cracker feed to form the feed stream to the cracking facility.

In an embodiment or in combination with any embodiment mentioned herein, the cracker feed stream can include a hydrocarbon feed other than the pyrolysis gas stream and/or the pyrolysis oil stream in an amount of from 5 to 95 weight percent, 10 to 90 weight percent, or 15 to 85 weight percent, based on the total weight of the cracker feed.

In an embodiment or in combination with any embodiment mentioned herein, the cracker facility may comprise a single cracking furnace, or it can have at least 2, or at least 3, or at least 4, or at least 5, or at least 6, or at least 7, or at least 8 or more cracking furnaces operated in parallel. Any one or each furnace(s) may be gas cracker, or a liquid cracker, or a split furnace.

The cracker feed stream, along with the pyrolysis oil stream 44 and/or pyrolysis gas 50, may pass through the cracking furnace, wherein the hydrocarbon components therein are thermally cracked to form lighter hydrocarbons, including olefins such as ethylene, propylene, and/or butadiene. The residence time of the cracker stream in the furnace can be in the range of from 0.15 to 2 seconds, 0.20 to 1.75 seconds, or 0.25 to 1.5 seconds.

The temperature of the cracked olefin-containing effluent 52 withdrawn from the furnace outlet can be in the range of from 730 to 900° C., 750 to 875° C., or 750 to 850° C.

In an embodiment or in combination with any embodiment mentioned herein, the recycle content olefin-containing stream 52 withdrawn from the separator 26 in the cracking facility (as shown in FIG. 1B) can comprise at least 10, at least 15, at least 20, at least 25, at least 30, at least 35, at least 40, at least 45, at least 50, at least 55, at least 60, at least 65, at least 70, at least 75, at least 80, at least 85, or at least 90 weight percent of recycle content C2 to C4 olefins, based on the total weight of the olefin-containing effluent stream. The recycle content olefin-containing stream may comprise predominantly recycle content ethylene, predominantly recycle content propylene, or predominantly recycle content ethylene and recycle content propylene, based on the total weight of the olefin-containing effluent stream.

In an embodiment or in combination with any embodiment mentioned herein, when introduced into the cracker facility, the pyrolysis gas stream 50 may be introduced into the inlet of the cracker furnace 20, or all or a portion of the pyrolysis gas stream 50 may be introduced downstream of the furnace outlet, at a location upstream of or within the separation zone of the cracker facility. When introduced into or upstream of the separation zone, the pyrolysis gas 50 can be introduced upstream of the last stage of compression in the compressor 24, or prior to the inlet of at least one fractionation column in a fractionation section of the separator 26.

Upon exiting the cracker furnace outlet, the olefin-containing effluent stream 52 may be cooled rapidly (e.g., quenched) in the quench system 22 in order to prevent production of large amounts of undesirable by-products and to minimize fouling in downstream equipment. The quench system 22 can yield the quenched olefin-containing effluent stream 54 and a waste quench fluid stream that may comprise water, residual quench oil, and/or residual steam.

In an embodiment or in combination with any embodiment mentioned herein, at least a portion of one or more of the above streams may be introduced into one or more of the facilities shown in FIG. 1B, while, in other embodiments, all or a portion of the streams withdrawn from the separation zone of the cracking facility may be routed to further separation and/or storage, transportation, sale, and/or use.

### Aromatics Recovery

Turning back to FIG. 1B, at least a portion of the pyrolysis oil stream 44 may be introduced into an aromatics recovery facility 30 comprising a conventional Benzene-Toluene-Xylene (BTX) Unit.

In an embodiment or in combination with any embodiment mentioned herein, one or more aromatics, such as benzene, toluene, and/or xylene, may be recovered from at least a portion of the pyrolysis oil stream in the aromatics recovery facility 30. Generally, in certain embodiments, at least a portion of the aromatics may be recovered from the pyrolysis oil stream via a solvent extraction process. The extraction solvents used in the solvent extraction may include, for example, tetrahydrofurfuryl alcohol (THFA), sulfolane, furfural, tetraethylene glycol, dimethylsulfoxide, N-methyl-2-pyrrolidone, or combinations thereof.

The aromatics recovery facility 30 shown in FIG. 1B can include various types of equipment including, but not limited to, a filter system, a multistage separator, a distillation column, a tank, a separatory funnel, a countercurrent distribution system, a membrane system, a Craig apparatus, a spray column, a centrifugal contractor, a thin layer extraction vessel, a pulsed column, and/or a mixer-settler. In certain embodiments, the aromatics recovery facility 30 in FIG. 1B can be a conventional Benzene-Toluene-Xylene (BTX) Unit, which are commonly used in the petrochemical industry.

The aromatics recovery facility 30 depicted in FIG. 1 can be used to recover most of the aromatics present in the pyrolysis oil stream 44. More particularly, the pyrolysis oil stream 44 can be introduced into the aromatics recovery facility 30, where it can flow in a countercurrent manner relative to one or more of the extraction solvents mentioned above. As the pyrolysis oil stream 44 flows through the aromatics recovery facility 30, the aromatics may be selectively dissolved in the extraction solvent.

### Molecular Reforming

Turning back to FIG. 1B, at least a portion of the pyrolysis oil stream 44 and/or the pyrolysis residue stream 46 may be introduced into a molecular reforming facility, such as a POX gasification unit 28. Exemplary molecular reforming facilities can include a partial oxidation (POX) gasification facility or a steam reforming facility. Thus, in such embodiments, the molecular reforming facility may comprise a POX gasifier or a steam reformer.

The reactions occurring within molecular reforming facility may include conversion of at least a portion of the pyrolysis oil stream 44 and/or the pyrolysis residue stream 46 into syngas, and specific examples include, but are not limited to partial oxidation, water gas shift, water gas—primary reactions, Boudouard, oxidation, methanation, hydrogen reforming, steam reforming, and carbon dioxide reforming.

In an embodiment or in combination with any embodiment mentioned herein, the molecular reforming facility comprises a POX gasification facility. The feed to POX gasification can include solids, liquids, and/or gases.

In the POX gasification facility 28, at least a portion of the pyrolysis oil stream and/or the pyrolysis residue stream may be converted to syngas in the presence of a sub-stoichiometric amount of oxygen.

The POX gasification facility 28 includes at least one POX gasification reactor. The POX gasification unit may comprise a gas-fed reactor (or gasifier). In an embodiment or in combination with any embodiment mentioned herein, the POX gasification facility may perform gas-fed POX gasification. As used herein, “gas-fed POX gasification” refers to a POX gasification process where the feed to the process comprises predominately (by weight) components that are gaseous at 25° C. and 1 atm.

Gas-fed POX gasification processes can be co-fed with lesser amounts of other components having a different phase at 25° C. and 1 atm. Thus, gas-fed POX gasifiers can be co-fed with liquids and/or solids, but only in amounts that are less (by weight) than the amount of gasses fed to the gas-phase POX gasifier.

In an embodiment or in combination with any embodiment mentioned herein, the total feed to a gas-fed POX gasifier can comprise at least 60, at least 70, at least 80, at least 90, or at least 95 weight percent of components that are gaseous at 25° C. and 1 atm.

In an embodiment or in combination with any embodiment mentioned herein, the type of gasification technology employed may be a partial oxidation entrained flow gasifier that generates syngas. This technology is distinct from fixed bed (alternatively called moving bed) gasifiers and from fluidized bed gasifiers. An exemplary gasifier that may be used in depicted in U.S. Pat. No. 3,544,291, the entire disclosure of which is incorporated herein by reference to the extent not inconsistent with the present disclosure. However, in an embodiment or in combination with any embodiment mentioned herein, other types of gasification reactors may also be used within the scope of the present technology.

In an embodiment or in combination with any embodiment mentioned herein, the gasification zone, and optionally all reaction zones in the gasifier/gasification reactor, may be operated at a temperature of at least 1000° C., at least 1100° C., at least 1200° C., at least 1250° C., or at least 1300° C. and/or not more than 2500° C., not more than 2000° C., not more than 1800° C., or not more than 1600° C. The reaction temperature may be autogenous. Advantageously, the gasifier operating in steady state mode may be at an autogenous temperature and does not require application of external energy sources to heat the gasification zone.

In an embodiment or in combination with any embodiment mentioned herein, the gasifier may be operated at a pressure within the gasification zone (or combustion chamber) of at least 200 psig (1.38 MPa), at least 300 psig (2.06 MPa), at least 350 psig (2.41 MPa), at least 400 psig (2.76 MPa), at least 420 psig (2.89 MPa), at least 450 psig (3.10 MPa), at least 475 psig (3.27 MPa), at least 500 psig (3.44 MPa), at least 550 psig (3.79 MPa), at least 600 psig (4.13 MPa), at least 650 psig (4.48 MPa), at least 700 psig (4.82 MPa), at least 750 psig (5.17 MPa), at least 800 psig (5.51 MPa), at least 900 psig (6.2 MPa), at least 1000 psig (6.89 MPa), at least 1100 psig (7.58 MPa), or at least 1200 psig (8.2 MPa). Additionally or alternatively, the gasifier may be operated at a pressure within the gasification zone (or combustion chamber) of not more than 1300 psig (8.96 MPa), not more than 1250 psig (8.61 MPa), not more than 1200 psig (8.27 MPa), not more than 1150 psig (7.92 MPa), not more than 1100 psig (7.58 MPa), not more than 1050 psig (7.23 MPa), not more than 1000 psig (6.89 MPa), not more than 900 psig (6.2 MPa), not more than 800 psig (5.51 MPa), or not more than 750 psig (5.17 MPa).

In an embodiment or in combination with any embodiment mentioned herein, the gasifier is a non-slagging gasifier or operated under conditions not to form a slag.

### Heat Integration With Multiple Streams

As noted above, we have discovered that the carbon footprint of the chemical recycling facility 10 may be lowered by recycling residual heat from various process streams back into the chemical recycling process. Turning again to FIG. 1A and FIG. 2, the chemical recycling facility 10 may contain one or more heat transfer medium loops or pathways, which can transfer at least a portion of the heat energy from the pyrolysis effluent stream 38, the pyrolysis oil stream 44, and/or the pyrolysis flue gas 40 to: (i) the waste plastic subjected to plastic liquification, (ii) the liquefied waste plastic 36 upstream of and/or within the pyrolysis reactor 14, (iii) a combustion fuel stream used to generate heat for the pyrolyzing of the waste plastics, and/or (iv) a combustion air stream used to generate heat for the pyrolyzing of the waste plastics. As shown in FIG. 1A, residual heat energy may be recovered from the pyrolysis effluent stream 38 and/or the pyrolysis oil stream 44 and applied to different positions within the chemical recycling facility 10.

As shown in FIG. 1A, the chemical recycling facility 10 may contain at least one heat transfer medium loop 56 containing at least one heat transfer medium that can transfer at least a portion of the heat energy from the pyrolysis effluent stream 38 back to: (i) the waste plastic feed stream 34 upstream of and/or in the plastic liquification system 12 and/or (ii) the liquefied waste plastic upstream of and/or within the pyrolysis reactor 14. As discussed below in greater detail, the heat transfer media (HTM) may operate within a heat transfer medium loop, which contains the heat transfer medium. As shown in FIG. 1A, while in the heat transfer medium loop, the heat transfer medium may be heated via indirect heat exchange with the pyrolysis effluent stream 38.

As shown in FIG. 1A, the heat transfer medium in the heat transfer medium loop may recover heat energy from at least a portion of the pyrolysis effluent 38 via at least one heat exchanger 58. While in these heat exchangers, the heat transfer medium can recover at least a portion of the heat energy from the pyrolysis effluent stream 38 via indirect heat exchange. The heat exchangers 58 can comprise any conventional cross-flow heat exchangers known in the art, such as a transfer line exchanger. In certain embodiments, the heat exchangers 58 may comprise a brazed aluminum heat exchanger comprising a plurality of cooling and warming passes (e.g., cores) disposed therein for facilitating indirect heat exchange between one or more process streams and at least one heat transfer medium stream. Although generally illustrated in FIG. 1A as comprising a single core or “shell,” it should be understood that the heat exchangers can comprise two or more separate core or shells.

After indirect heat exchange with the pyrolysis effluent stream 38, the temperature of the heat transfer medium in the heat transfer medium loop 56 can increase by at least 25, at least 50, at least 75, at least 100, at least 125, at least 150, at least 175, or at least 200° C. and/or not more than 400, not more than 350, not more than 300, or not more than 250° C.

In an embodiment or in combination with any embodiment mentioned herein, after indirect heat exchange with the pyrolysis effluent stream 38, the heated heat transfer medium may have a temperature of at least 150, at least 175, at least 200, at least 210, at least 220, at least 230, at least 240, at least 250, at least 260, at least 270, at least 280, at least 290, at least 300, at least 320, at least 340, at least 350, at least 360, at least 370, at least 380, at least 390, or at least 400° C. Additionally, or alternatively, after indirect heat exchange with the pyrolysis effluent stream 38, the heated heat transfer medium may have a temperature of less than 600, less than 550, less than 500, less than 450, less than 400, less than 390, less than 380, less than 370, less than 360, less than 350, less than 340, less than 330, less than 320, less than 310, less than 300, or less than 290° C. In various embodiments, after indirect heat exchange with the pyrolysis effluent stream 38, the heated heat transfer medium may have a temperature in the range of 200 to 600° C., 250 to 550° C., 290 to 500° C., or 300 to 450° C.

Turning again to FIG. 1A, after withdrawing heat energy from the pyrolysis effluent stream 38, at least a portion of the heat transfer medium in the heat transfer medium loop may be routed to the plastic liquification system 12. While in the liquification system 12, the heated heat transfer medium may provide heat energy to the plastic liquification processes described herein. For example, the liquification vessel (e.g., the melt tank and/or extruder) may comprise: (i) internal coils through which the heated transfer medium can flow and/or (ii) external coils and/or jacketing that allows the heated heat transfer medium to flow therethrough and thereby provide heat energy to the plastic liquification process occurring in the liquification vessel.

In an embodiment or in combination with any embodiment mentioned herein, the heated heat transfer medium may provide heat energy via indirect heat exchange to the plastic liquification system 12 by: (i) routing the heated heat transfer medium through one or more internal coils within the liquification vessel (e.g., a melt tank, a CSTR, and/or an extruder); (ii) routing the heated heat transfer medium through one or more external coils outside of the liquification vessel (e.g., a melt tank, a CSTR, and/or an extruder); (iii) routing the heated heat transfer medium through a heating jacket positioned outside of the liquification vessel (e.g., a melt tank, a CSTR, and/or an extruder); and/or (iv) routing the heated heat transfer medium through an external heat exchanger (not shown) within the liquification system 12.

Additionally, or alternatively, as shown in FIG. 1A, the heated heat transfer medium may also provide heat energy to the waste plastic feed stream 34 via indirect heat exchange in a heat exchanger 58, prior to introducing the waste plastic feed stream 34 into the liquification system 12. Consequently, this can further heat the waste plastics in the waste plastic feed stream 34. Thus, due to its increased temperature, the heated waste plastic feed stream can further facilitate the plastic liquification processes occurring in the liquification system 12.

The heat transfer medium can be any conventional heat transfer medium known in the art. In an embodiment or in combination with any embodiment mentioned herein, the heat transfer medium can be a non-aqueous fluid or an aqueous fluid (e.g., water and/or steam). The heat transfer medium may also be a single-phase medium (e.g., liquid or vapor) or a two-phase medium (e.g., liquid/vapor) while in the loop. In certain embodiments, the heat transfer medium may be in a liquid phase prior to heating (e.g., water) and then transition to another phase (e.g., steam) or a mixed phase (e.g., water/steam) upon heating.

Examples of suitable non-aqueous heat transfer media that can be used as the heat transfer medium includes an oil, a siloxane, a molten metal, a molten salt, or a combination thereof.

In an embodiment or in combination with any embodiment mentioned herein, the heat transfer medium comprises a non-aqueous heat transfer medium, such as a synthetic oil (e.g., THERMINOL®), a refined oil (e.g., a mineral oil), or a combination thereof. As used herein, a “refined oil” refers to a natural (i.e., non-synthetic) oil that has been subjected to a distillation and/or or purification step.

In an embodiment or in combination with any embodiment mentioned herein, the heat transfer medium comprises a molten salt. Exemplary molten salts include sodium chloride, sodium nitrate, potassium nitrate, or a combination thereof.

In an embodiment or in combination with any embodiment mentioned herein, the heat transfer medium comprises a molten metal. Exemplary molten metals can include lithium, gallium, sodium, cadmium, potassium, indium, lead, tin, bismuth, thallium, or a combination thereof.

In an embodiment or in combination with any embodiment mentioned herein, the heat transfer medium comprises an aqueous fluid, such as steam and/or water. If the heat transfer medium comprises steam, then the heat transfer medium loop may be in fluid communication with an HTM source, such as a steam generator, that provides the steam and/or water. In certain embodiments, the steam generator may generate the heat transfer medium from boiler feed water derived from the cracker facility. Additionally, or alternatively, the steam generator may also comprise a temperator for adding additional heat energy to the heat transfer medium that is provided.

In an embodiment or in combination with any embodiment mentioned herein, the heat transfer medium comprises steam. The steam can comprise a pressure of at least 700, at least 800, at least 900, at least 1,000, at least 1,100, at least 1,200, at least 1,300, at least 1,400, at least 1,500, or at least 1590 psi and/or less than 2,000, less than 1,800, less than 1,700, or less than 1,650 psi. In certain embodiments, the steam can comprise 1,600 psi steam.

Turning again to FIG. 1A, at least a portion of the pyrolysis oil stream 44 from the separation system 16 (e.g., the distillation column) may be routed upstream so as to provide further heat energy to the waste plastic feedstock and/or pyrolysis reaction. Generally, in an embodiment or in combination with any embodiment mentioned herein, the pyrolysis oil stream has a temperature in the range of 200 to 400° C., 225 to 375° C., or 250 to 350° C. when exiting the separation system 16 (e.g., the distillation column).

In an embodiment or in combination with any embodiment mentioned herein, as shown in FIG. 1A, at least a portion of the pyrolysis oil stream may be further heated via indirect heat exchange with the pyrolysis effluent stream 38 in at least one heat exchanger 60. While in these heat exchangers 60, the pyrolysis oil stream 44 can recover at least a portion of the heat energy from the pyrolysis effluent stream 38 via indirect heat exchange. The heat exchangers 60 can comprise any conventional cross-flow heat exchangers known in the art, such as a transfer line exchanger. In certain embodiments, the heat exchangers 60 may comprise a brazed aluminum heat exchanger comprising a plurality of cooling and warming passes (e.g., cores) disposed therein for facilitating indirect heat exchange between one or more process streams and at least one heat transfer medium stream. Although generally illustrated in FIG. 1A as comprising a single core or “shell,” it should be understood that the heat exchangers 60 can comprise two or more separate core or shells.

After indirect heat exchange with the pyrolysis effluent stream 38, the temperature of the heated pyrolysis oil stream 44 can increase by at least 10, at least 25, at least 50, at least 75, at least 100, or at least 125° C. and/or not more than 400, not more than 350, not more than 300, or not more than 250° C.

In an embodiment or in combination with any embodiment mentioned herein, after indirect heat exchange with the pyrolysis effluent stream 38, the heated pyrolysis oil stream 44 may have a temperature of at least 200, at least 210, at least 220, at least 225, at least 240, at least 250, at least 260, at least 270, at least 280, at least 290, at least 300, at least 320, at least 340, at least 350, at least 360, at least 370, at least 380, at least 390, or at least 400° C. Additionally, or alternatively, after indirect heat exchange with the pyrolysis effluent stream 38, the heated pyrolysis oil medium may have a temperature of less than 600, less than 550, less than 500, less than 450, less than 400, less than 390, less than 380, less than 370, or less than 360° C. In various embodiments, after indirect heat exchange with the pyrolysis effluent stream 38, the heated pyrolysis oil stream 44 may have a temperature in the range of 200 to 500° C., 225 to 450° C., or 250 to 400° C.

Alternatively, if the temperature of the pyrolysis oil stream 44 is sufficiently high enough, the indirect heat exchange step with the pyrolysis effluent stream 38 may be omitted, as shown in FIG. 1A.

Generally, prior to combining the pyrolysis oil stream 44 (or the heated pyrolysis oil stream) with the waste plastic and/or liquefied waste plastic, the pyrolysis oil stream (or the heated pyrolysis oil stream) has a temperature that is at least 10, at least 25, at least 50, at least 75, or at least 100° C. higher than the temperature of the waste plastic and/or liquefied waste plastic.

As shown in FIG. 1A, at least a portion of the pyrolysis oil stream 44 (or the heated pyrolysis oil stream) may be combined with at least a portion of the liquefied waste plastic 36 in and/or upstream of the pyrolysis reactor 14. Thus, the pyrolysis oil stream (or the heated pyrolysis oil stream) can provide additional heat energy to the liquefied waste plastic stream prior to and/or during pyrolysis. Generally, the pyrolysis oil stream 44 (or the heated pyrolysis oil stream) can be combined with the liquefied waste plastic stream 36 downstream of the plastic liquification system 12. Furthermore, in such embodiments, at least a portion of the pyrolysis oil stream 44 (or the heated pyrolysis oil stream) may be subjected once again to pyrolysis in the pyrolysis reactor 14.

Finally, as shown in FIG. 1A, a reboiler stream 62 may be removed from the separation system 16 (e.g., the distillation column) and heated via indirect heat exchange with at least a portion of the pyrolysis effluent stream 38 in a heat exchanger 64. While in these heat exchangers 64, the reboiler stream 62 can recover at least a portion of the heat energy from the pyrolysis effluent stream 38 via indirect heat exchange. The heat exchangers 64 can comprise any conventional cross-flow heat exchangers known in the art, such as a transfer line exchanger. In certain embodiments, the heat exchangers 64 may comprise a brazed aluminum heat exchanger comprising a plurality of cooling and warming passes (e.g., cores) disposed therein for facilitating indirect heat exchange between one or more process streams and at least one heat transfer medium stream. Although generally illustrated in FIG. 1A as comprising a single core or “shell,” it should be understood that the heat exchangers 64 can comprise two or more separate core or shells. The heated reboiler stream 62 may then be reintroduced into the distillation column so as to provide additional heat to the column. Furthermore, this may also lower the temperature of the pyrolysis effluent stream 38, thereby facilitating its separation in the separation system 16.

As shown in FIG. 2, at least a portion of the pyrolysis flue gas may be recovered and utilized in a heat transfer medium (“HTM”) loop 66. As depicted in FIG. 2, at least a portion of the pyrolysis flue gas 40 may be recovered and provide heat energy to the combustion fuel stream used to generate heat for the pyrolyzing of the waste plastics and/or the combustion air stream used to generate heat for the pyrolyzing of the waste plastics. The heat exchange between the pyrolysis flue gas and the combustion fuel stream and/or the combustion air stream can occur via indirect heat exchange in a heat exchanger 68. The heat exchangers 68 can comprise any conventional cross-flow heat exchangers known in the art, such as a transfer line exchanger. In certain embodiments, the heat exchangers 68 may comprise a brazed aluminum heat exchanger comprising a plurality of cooling and warming passes (e.g., cores) disposed therein for facilitating indirect heat exchange between one or more process streams and at least one heat transfer medium stream. Although generally illustrated in FIG. 2 as comprising a single core or “shell,” it should be understood that the heat exchangers 68 can comprise two or more separate core or shells.

As shown in FIG. 2, the terms “HTM Out” and “HTM In” are used for purposes of brevity and depict where the noted pyrolysis flue gas 40 may be recovered and/or introduced downstream in the chemical recycling facility 10. Although not depicted in FIG. 2, the pyrolysis flue gas 40 may be subjected to additional processing and/or separation after the “HTM Out” notation and prior to the “HTM In” notation.

In an embodiment or in combination with any embodiment mentioned herein, the pyrolysis flue gas 40 may have a temperature of at least 80° C., at least 90° C., at least 100° C., or at least 110° C. Additionally, or in the alternative, the pyrolysis flue gas may have a temperature of not more than 260° C., not more than 250° C., not more than 240° C., not more than 230° C., not more than 220° C., not more than 210° C., not more than 200° C., not more than 190° C., not more than 180° C., not more than 170° C., not more than 160° C., or not more than 150° C. In certain embodiments, the pyrolysis flue gas 40 may have a temperature in the range of 80 to 260° C., 90 to 260° C., 100 to 260° C., or 110 to 260° C.

After indirect heat exchange with the pyrolysis flue gas 40, the treated stream (i.e., the combustion fuel stream and/or the combustion air stream) may increase in temperature. In an embodiment or in combination with any embodiment mentioned herein, after indirect heat exchange with the pyrolysis flue gas, the temperature of the treated stream can increase by at least 5, at least 10, at least 25, at least 50, at least 75, at least 100, at least 125, at least 150, at least 175, or at least 200° C. and/or not more than 300, not more than 250, not more than 200, or not more than 150° C.

### Definitions

It should be understood that the following is not intended to be an exclusive list of defined terms. Other definitions may be provided in the foregoing description, such as, for example, when accompanying the use of a defined term in context.

As used herein, the terms “a,” “an,” and “the” mean one or more.

As used herein, the term “and/or,” when used in a list of two or more items, means that any one of the listed items can be employed by itself or any combination of two or more of the listed items can be employed. For example, if a composition is described as containing components A, B, and/or C, the composition can contain A alone; B alone; C alone; A and B in combination; A and C in combination, B and C in combination; or A, B, and C in combination.

As used herein, the phrase “at least a portion” includes at least a portion and up to and including the entire amount or time period.

As used herein, “aqueous” refers to a fluid containing at least five percent of molecular water by weight.

As used herein, the term “aromatics recovery facility” refers to a facility that includes all equipment, lines, and controls necessary to recover at least a portion of the aromatics present in a feed stream.

As used herein, the term “bottom” refers to the physical location of a structure that is below the other noted structures within an enclosed structure. For example, a “bottom” stream is a stream taken from a vessel at a position that is lower elevation-wise to other streams taken from the vessel, such as an “overhead” stream.

As used herein, the term “chemical recycling” refers to a waste plastic recycling process that includes a step of chemically converting waste plastic polymers into lower molecular weight polymers, oligomers, monomers, and/or non-polymeric molecules (e.g., hydrogen, carbon monoxide, methane, ethane, propane, ethylene, and propylene) that are useful by themselves and/or are useful as feedstocks to another chemical production process(es).

As used herein, the term “chemical recycling facility” refers to a facility for producing a recycle content product via chemical recycling of waste plastic.

As used herein, the term “co-located” refers to the characteristic of at least two objects being situated on a common physical site, and/or within one mile of each other.

As used herein, the terms “comprising,” “comprises,” and “comprise” are open-ended transition terms used to transition from a subject recited before the term to one or more elements recited after the term, where the element or elements listed after the transition term are not necessarily the only elements that make up the subject.

As used herein, the term “cracking” refers to breaking down complex organic molecules into simpler molecules by the breaking of carbon-carbon bonds.

As used herein, the term “depleted” refers to having a concentration (on a dry weight basis) of a specific component that is less than the concentration of that component in a reference material or stream.

As used herein, the term “directly derived” refers to having at least one physical component originating from waste plastic.

As used herein, the term “enriched” refers to having a concentration (on a dry weight basis) of a specific component that is greater than the concentration of that component in a reference material or stream.

As used herein, the terms “exhaustion” or “exhausting” refer to methods for disposing of the specified stream by removing the stream from the facility. Exemplary exhaustion methods can include venting.

As used herein, the term “fluid” may encompass a liquid, a gas, a supercritical fluid, or a combination thereof.

As used herein, the term “halide” refers to a composition comprising a halogen atom bearing a negative charge (i.e., a halide ion).

As used herein, the term “halogen” or “halogens” refers to organic or inorganic compounds, ionic, or elemental species comprising at least one halogen atom.

As used herein, the terms “having,” “has,” and “have” have the same open-ended meaning as “comprising,” “comprises,” and “comprise” provided above.

As used herein, a “heat transfer medium loop” or “HTM loop” refers to a system comprising one or more heat exchangers through which a common HTM is circulated to a common HTM supply or a part of a larger system for the purpose of transferring heat and/or energy into and/or out of the chemical recycling process.

As used herein, the terms “including,” “include,” and “included” have the same open-ended meaning as “comprising,” “comprises,” and “comprise” provided above.

As used herein, the term “indirectly derived” refers to having an assigned recycle content i) that is attributable to waste plastic, but ii) that is not based on having a physical component originating from waste plastic.

As used herein, the term “isolated” refers to the characteristic of an object or objects being by itself or themselves and separate from other materials, in motion or static.

As used herein, the terms “mixed plastic waste” and “MPW” refer to a mixture of at least two types of waste plastics including, but not limited to the following plastic types: polyethylene terephthalate (PET), one or more polyolefins (PO), and polyvinylchloride (PVC).

As used herein, the term “molecular reforming” refers to partial oxidation (POX) Gasification and steam reforming.

As used herein, the term “molecular reforming facility” refers to a facility that includes all equipment, lines, and controls necessary to carry out molecular reforming of waste plastic and feedstocks derived therefrom.

As used herein, “non-aqueous” refers to a fluid containing less than five percent of molecular water by weight.

As used herein, the term “overhead” refers to the physical location of a structure that is above a maximum elevation of quantity of particulate plastic solids within an enclosed structure. For example, an “overhead” stream is a stream taken from a vessel at a position that is higher elevation-wise to other streams taken from the vessel, such as a “bottom” stream.

As used herein, the term “partially processed waste plastic” means waste plastic that has been subjected to at least on automated or mechanized sorting, washing, or comminuted step or process. Partially processed waste plastics may originate from, for example, municipal recycling facilities (MRFs) or reclaimers. When partially processed waste plastic is provided to the chemical recycling facility, one or more preprocessing steps may me skipped.

As used herein, the term “physical recycling” (also known as “mechanical recycling”) refers to a waste plastic recycling process that includes a step of melting waste plastic and forming the molten plastic into a new intermediate product (e.g., pellets or sheets) and/or a new end product (e.g., bottles). Generally, physical recycling does not substantially change the chemical structure of the plastic, although some degradation is possible.

As used herein, the term “plastic” may include any organic synthetic polymers that are solid at 25° C. and 1 atmosphere of pressure.

As used herein, the terms “partial oxidation (POX) gasification” or “POX gasification” refers to high temperature conversion of a carbon-containing feed into syngas, (carbon monoxide, hydrogen, and carbon dioxide), where the conversion is carried out in the presence of a less than stoichiometric amount of oxygen. The feed to POX gasification can include solids, liquids, and/or gases.

As used herein, the term “partial oxidation (POX) reaction” refers to all reactions occurring within a partial oxidation (POX) gasifier in the conversion of a carbon-containing feed into syngas, including but not limited to partial oxidation, water gas shift, water gas-primary reactions, Boudouard, oxidation, methanation, hydrogen reforming, steam reforming, and carbon dioxide reforming.

As used herein, the term “predominantly” means more than 50 percent by weight. For example, a predominantly propane stream, composition, feedstock, or product is a stream, composition, feedstock, or product that contains more than 50 weight percent propane.

As used herein, the term “preprocessing” refers to preparing waste plastic for chemical recycling using one or more of the following steps: (i) comminuting, (ii) particulating, (iii) washing, (iv) drying, and/or (v) separating.

As used herein, the term “pyrolysis” refers to thermal decomposition of a feedstock of a biomass and/or a plastic material in solid or liquid form at elevated temperatures in an inert (i.e., substantially molecular oxygen free) atmosphere.

As used herein, the term “pyrolysis char” refers to a carbon-containing composition obtained from pyrolysis that is solid at 200° C. and 1 atm.

As used herein, the terms “pyrolysis gas” and “pygas” refer to a composition obtained from pyrolysis that is gaseous at 25° C. at 1 atm.

As used herein, the term “pyrolysis heavy waxes” refers to C20+ hydrocarbons obtained from pyrolysis that are not pyrolysis char, pyrolysis gas, or pyrolysis oil.

As used herein, the terms “pyrolysis oil” or “pyoil” refers to a composition obtained from pyrolysis that is liquid at 25° C. and 1 atm.

As used herein, the term “pyrolysis residue” refers to a composition obtained from pyrolysis that is not pyrolysis gas or pyrolysis oil and that comprises predominantly pyrolysis char and pyrolysis heavy waxes.

As used herein, the terms “recycle content” and “r-content” refer to being or comprising a composition that is directly and/or indirectly derived from waste plastic.

As used herein, the terms “r-pyrolysis gas” or “r-pygas” refer to being or comprising a pyrolysis gas that is directly and/or indirectly derived from waste plastic.

As used herein, the terms “r-pyrolysis oil” or “r-pyoil” refer to being or comprising a pyrolysis oil that is directly and/or indirectly derived from waste plastic.

As used herein, the term “residual” refers to a remaining quantity or amount of an identified product or component that remains from an original source containing the product or component. For example, a “residual pyrolysis oil” may refer to the remaining pyrolysis oil from an initial pyrolysis effluent after the majority of the pyrolysis oil has been previously removed therefrom.

As used herein, the terms “waste plastic” and “plastic waste” refer to used, scrap, and/or discarded plastic materials. The waste plastic fed to the chemical recycling facility may be unprocessed or partially processed.

As used herein, the term “unprocessed waste plastic” means waste plastic that has not be subjected to any automated or mechanized sorting, washing, or comminuting. Examples of unprocessed waste plastic include waste plastic collected from household curbside plastic recycling bins or shared community plastic recycling containers.

As used herein, “downstream” means a target unit operation, vessel, or equipment that:
a. is in fluid (liquid or gas) communication, or in piping communication, with an outlet stream from the radiant section of a cracker furnace, optionally through one or more intermediate unit operations, vessels, or equipment, or
b. was in fluid (liquid or gas) communication, or in piping communication, with an outlet stream from the radiant section of a cracker furnace, optionally through one or more intermediate unit operations, vessels, or equipment, provided that the target unit operation, vessel, or equipment remains within the battery limits of the cracker facility (which includes the furnace and all associated downstream separation equipment).

### Claims Not Limited to Disclosed Embodiments

When a numerical sequence is indicated, it is to be understood that each number is modified the same as the first number or last number in the numerical sequence or in the sentence, e.g., each number is “at least,” or “up to” or “not more than” as the case may be; and each number is in an “or” relationship. For example, “at least 10, 20, 30, 40, 50, 75 wt. % . . . ” means the same as “at least 10 wt. %, or at least 20 wt. %, or at least 30 wt. %, or at least 40 wt. %, or at least 50 wt. %, or at least 75 wt. %,” etc.; and “not more than 90 wt. %, 85, 70, 60 . . . ” means the same as “not more than 90 wt. %, or not more than 85 wt. %, or not more than 70 wt. % . . . ” etc.; and “at least 1%, 2%, 3%, 4%, 5%, 6%, 7%, 8%, 9% or 10% by weight . . . ” means the same as “at least 1 wt. %, or at least 2 wt. %, or at least 3 wt. % . . . ” etc.; and “at least 5, 10, 15, 20 and/or not more than 99, 95, 90 weight percent” means the same as “at least 5 wt. %, or at least 10 wt. %, or at least 15 wt. % or at least 20 wt. % and/or not more than 99 wt. %, or not more than 95 wt. %, or not more than 90 weight percent . . . ” etc.

The preferred forms of the invention described above are to be used as illustration only and should not be used in a limiting sense to interpret the scope of the present invention. Modifications to the exemplary embodiments, set forth above, could be readily made by those skilled in the art without departing from the spirit of the present invention.

The inventors hereby state their intent to rely on the Doctrine of Equivalents to determine and assess the reasonably fair scope of the present invention as it pertains to any apparatus not materially departing from but outside the literal scope of the invention as set forth in the following claims.

1. A chemical recycling process comprising:
(a) liquefying at least a portion of a waste plastic in a liquification system to form a liquefied waste plastic;
(b) pyrolyzing at least a portion of the liquefied waste plastic in a pyrolysis zone to produce a pyrolysis effluent stream;
(c) separating at least a portion of the pyrolysis effluent stream in a distillation column to thereby recover a pyrolysis oil stream; and
(d) combining at least a portion of the pyrolysis oil stream with at least a portion of the liquefied waste plastic in and/or upstream of the pyrolysis zone.

2. The process according to claim 1, wherein the pyrolysis oil stream has a temperature that is at least 10, at least 25, at least 50, at least 75, or at least 100° C. higher than the temperature of the liquefied waste plastic when the pyrolysis oil stream is combined with the liquefied waste plastic.

3. The process according to claim 1, wherein the pyrolysis oil stream has a temperature in the range of 200 to 500° C., 225 to 450° C., or 250 to 400° C. when combined with the liquefied waste plastic.

4. The process according to claim 1, wherein the pyrolysis oil stream has a temperature in the range of 200 to 400° C., 225 to 375° C., or 250 to 350° C. when exiting the distillation column.

5. The process according to claim 4, further comprising heating at least a portion of the pyrolysis oil stream via indirect heat exchange with the pyrolysis effluent stream to form a heated pyrolysis oil stream, wherein the heated pyrolysis oil stream is the pyrolysis oil stream in the combining step.

6. The process according to claim 5, wherein the heated pyrolysis oil stream has a temperature that is at least 10, at least 25, at least 50, at least 75, or at least 100° C. higher than the temperature of the pyrolysis oil stream before the heating with the pyrolysis effluent stream.

7. The process according to claim 6, wherein the heated pyrolysis oil stream has a temperature in the range of 200 to 500° C., 225 to 450° C., or 250 to 400° C. when combined with the liquefied waste plastic.

8. The process according to claim 7, wherein the pyrolysis oil stream comprises at least 50, at least 55, at least 60, at least 65, at least 70, at least 75, at least 80, at least 85, at least 90, or at least 95 weight percent of C₅ to C₁₄ hydrocarbons, based on the total weight of the pyrolysis oil stream.

9. The process according to claim 8, wherein the separating of step (c) also forms a pyrolysis vapor stream and a pyrolysis residue stream.

10. The process according to claim 9, wherein the pyrolysis residue stream comprises at least 50, at least 55, at least 60, at least 65, at least 70, at least 75, at least 80, at least 85, at least 90, or at least 95 weight percent of C₁₅₊ hydrocarbons, based on the total weight of the pyrolysis residue stream.

11. The process according to claim 10, further comprising separating the pyrolysis vapor stream into a pyrolysis gas stream and an enriched C5+ hydrocarbon stream.

12. The process according to claim 11, further comprising introducing at least a portion of the enriched C5+ hydrocarbon stream back into the distillation column.

13. The process according to claim 12, wherein the enriched C5+ hydrocarbon stream comprises at least 50, at least 55, at least 60, at least 65, at least 70, at least 75, at least 80, at least 85, at least 90, or at least 95 weight percent of C₅ to C₁₄ hydrocarbons, based on the total weight of the stream.

14. The process according to claim 13, wherein the pyrolysis gas stream comprises at least 50, at least 55, at least 60, at least 65, at least 70, at least 75, at least 80, at least 85, at least 90, or at least 95 weight percent of C1 to C4 hydrocarbons, based on the total weight of the pyrolysis gas stream.

15. The process according to claim 14, further comprising introducing at least a portion of the pyrolysis gas stream into a cracking facility.

16. The process according to claim 15, further comprising introducing at least a portion of the pyrolysis gas stream into a compression system of a cracking facility.

17. The process according to claim 16, further comprising introducing at least a portion of the pyrolysis oil stream into a molecular reforming facility, a cracking facility, and/or an aromatics recovery facility.

18. The process according to claim 17, further comprising providing a heat transfer media loop comprising a heat transfer medium, further comprising preheating at least a portion of the waste plastic prior to the liquefying of step (a) and/or at least a portion of the liquefied waste plastic prior to the pyrolyzing of step (b) via indirect heat exchange with the heat transfer medium.

19. The process according to claim 18, further comprising heating at least a portion of the heat transfer medium via indirect heat exchange with the pyrolysis effluent stream to form a heated heat transfer medium.

20. The process according to claim 19, wherein the pyrolyzing comprises combusting a combustion fuel and/or a combustion air to generate heat and a pyrolysis flue gas.
